(19) United States
(12) Patent Application Publication
(10) Pub. No.: US 2022/0015058 A1
(43) Pub. Date: Jan. 13, 2022

(54) METHOD AND DEVICE FOR POSITIONING CONFIGURATION AND REPORTING

(71) Applicant: Samsung Electronics Co., Ltd., Suwon-si (KR)

(72) Inventors: Lisi LI, Beijing (CN); Hong WANG, Beijing (CN); Lixiang XU, Beijing (CN); Weiwei WANG, Beijing (CN)

(21) Appl. No.: 17/368,195

(22) Filed: Jul. 6, 2021

(30) Foreign Application Priority Data
Jul. 8, 2020 (CN) 202010653282.0

(51) Int. Cl. H04W 64/00

(52) U.S. Cl. CPC H04W 64/00

(57) ABSTRACT

The present disclosure relates to a communication method and system for converging a 5^{th}-Generation (5G) communication system for supporting higher data rates beyond a 4^{th}-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. The disclosure relates to a method for positioning, which includes sending a positioning information request by a first entity to one or more second entities, receiving positioning information response by the first entity. In addition, the disclosure further relates to a method for positioning, which includes sending a request message related to positioning by a first entity to a second entity, and receiving a response message from a second entity by the first entity.

### CROSS-REFERENCE TO RELATED APPLICATION(S)

This application is based on and claims priority under 35 U.S.C. § 119(a) of a Chinese patent application number 202010653282.0, filed on Jul. 8, 2020, in the Chinese National Intellectual Property Administration, the disclosure of which is incorporated by reference herein in its entirety.

### BACKGROUND

### 1. Field

The disclosure relates to the field of communication. More particularly, the disclosure relates to a method and a device for positioning configuration and reporting.

### 2. Description of Related Art

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

In order to meet the increasing demand for wireless data communication services since the deployment of 4th generation (4G) communication systems, efforts have been made to develop improved 5th generation (5G) or quasi-5G communication systems. Therefore, 5G or quasi-5G communication systems are also called “super 4G network” or “post-long term evolution (LTE) system”.

Wireless communication is one of the most successful innovations in the modern history. Recently, the number of subscribers of wireless communication services has exceeded 5 billion, and continues to grow rapidly. With the increasing popularity of smart phones and other mobile data devices (such as tablet computers, notebook computers, netbooks, e-book readers and machine-type devices) in consumers and enterprises, the demand for wireless data services is growing rapidly. In order to meet the rapid growth of mobile data services and to support new applications and deployments, it is very important to improve the efficiency and expand the coverage of wireless interfaces.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and a device for positioning configuration and reporting.

Additional aspects will be set forth in part in the description which follows and, in part, will be apparent from the description, or may be learned by practice of the presented embodiments.

In accordance with an aspect of the disclosure, a method for positioning is provided. The method includes sending a request for positioning information by a first entity to one or more second entities, and receiving response for positioning information by the first entity.

In an implementation, the request is one of the following a request for positioning assistance information, a request for positioning measurement, and a request for user equipment (UE) geographic location information, and the response is one of the following response of positioning assistance information, response of positioning measurement information, and response of UE geographic location information.

In one implementation, the positioning assistance information includes at least one of information about a change in a positioning reference point or information about a gateway related to the positioning reference point.

In an implementation, the information about the change in the positioning reference point includes information indicating a movement trajectory and a corresponding time of the positioning reference point.

In an implementation, the information about the change of the positioning reference point includes at least one of the following non-terrestrial networks ID (NTN ID), NTN beam ID, or NTN gateway ID.

In an implementation, the NTN ID includes a satellite ID, the NTN beam ID includes a satellite beam ID, and the NTN gateway ID includes an ID of a terrestrial gateway connected to a satellite.

In an implementation, the request for positioning measurement includes a request for at least one of Doppler measurement, carrier phase measurement and code phase measurement, and the positioning measurement information includes at least one of the following Doppler shift measurement value, carrier phase measurement value, code phase measurement value, channel model, channel offset, or a receiving satellite beam number, a satellite ID, an ID of a terrestrial gateway connected to a satellite.

In an implementation, in the case that the second entity is UE, the request for positioning measurement and the response of positioning measurement information are transmitted in radio resource control (RRC) messages.

In an implementation, the message is one of the following a RRC reconfiguration message, a positioning measurement request message, or a positioning information request message.

In an implementation, the request for positioning information and the response for positioning information are transmitted using messages of Xn protocol or NRPPa protocol encapsulated in Xn protocol.

In an implementation, the method according to the embodiment of the disclosure further includes if a trigger event occurs or reaching the time corresponding to an updating period, receiving a positioning information update by the first entity.

In one implementation, the method according to the embodiment of the disclosure further includes sending positioning measurement configuration by a first entity to a second entity, and if the positioning measurement configuration changes, sending a message indicating an update of the positioning measurement to the one or more second entities, or if the positioning procedure ends, sending a message indicating a stop of the positioning measurement to the one or more second entities.

In an implementation, the first entity and the second entity are one of the following the first entity is a base station, and the second entity is one of a base station, a UE, a location management function (LMF), a distribute unit (DU) and a central unit (CU), the first entity is a LMF and the second entity is a base station, the first entity is a CU, the second entity is one of a DU, a base station and a CU, the first entity is a UE and the second entity is a base station, the first entity is a DU and the second entity is a CU, the first entity is a CU user plane (CU-UP), and the second entity is one of a CU-CP, a base station, a DU and a CU, the first entity is a CU control plane (CU-CP), and the second entity is a CU-UP, the first entity is a core network and the second entity is a base station, or the first entity is an entity with a LMF in the base station, and the second entity is one of a CU-CP, a CU-UP and a DU.

In an implementation, the request includes positioning information related to the UE, the response includes one of the following the content of and the reason for rejection, or new positioning measurement configuration, and if the response includes new positioning measurement configuration, sending an RRC reconfiguration message including the new positioning measurement configuration by the first entity to the UE.

In an implementation, the response includes positioning information related to the UE, and the method further includes if the first entity has a location management capability, sending an RRC reconfiguration message including new positioning measurement configuration by the first entity to the UE.

In an implementation, the positioning information related to UE includes one or more of a UE measurement ID, measurement configuration, a measurement result, or positioning assistance information related to the positioning of the UE, the new positioning measurement configuration includes one or more of a new UE measurement ID, new measurement configuration, new positioning assistance information, and calculated location information of the UE.

In one implementation, the request is a handover request, and the response is a handover request acknowledgement, or the request is a handover required, and the response is a handover command, or the request is a retrieve UE context request, and the response is a retrieve UE context response.

In accordance with another aspect of the disclosure, a method for positioning information request is provided. The method includes receiving a request for positioning information from a first entity by a second entity, sending response for positioning information by the second entity.

In an implementation, the request is one of the following a request for positioning assistance information, a request for positioning measurement, and a request for UE geographic location information, and wherein the response is one of the following response of positioning assistance information, response of positioning measurement information, and response of UE geographic location information.

In one implementation, the positioning assistance information includes at least one of information about a change in a positioning reference point or information about a gateway related to the positioning reference point.

In an implementation, the information about the change in the positioning reference point includes information indicating a movement trajectory and a corresponding time of the positioning reference point.

In an implementation, the information about the change of the positioning reference point includes at least one of the following non-terrestrial networks ID (NTN ID), NTN beam ID, or NTN gateway ID.

In an implementation, the NTN ID includes a satellite ID, the NTN beam ID includes a satellite beam ID, and the NTN gateway ID includes es an ID of a terrestrial gateway connected to a satellite.

In an implementation, the request for positioning measurement includes a request for at least one of Doppler measurement, carrier phase measurement and code phase measurement, and the positioning measurement information includes at least one of the following Doppler shift measurement value, carrier phase measurement value, code phase measurement value, channel model, channel offset, or a receiving satellite beam number, a satellite ID, an ID of a terrestrial gateway connected to a satellite.

In an implementation, the second entity is a UE, the request for positioning measurement and the response of positioning measurement information are transmitted in RRC messages.

In an implementation, the message is one of the following a RRC reconfiguration message, a positioning measurement request message, or a positioning information request message.

In an implementation, the request for positioning information and the response for positioning information are transmitted using messages of Xn protocol or NRPPa protocol encapsulated in Xn protocol.

In an implementation, the method according to the embodiment of the disclosure further includes if a trigger event occurs or reaching the time corresponding to an updating period, sending a positioning information update by the second entity to the first entity.

In one implementation, the method according to the embodiment of the disclosure further includes receiving positioning measurement configuration by the second entity, and receiving, by the second entity, a message indicating an update of positioning measurement in the case that the positioning measurement configuration changes, or receiving, by the second entity, a message indicating a stop of positioning measurement if the positioning procedures ends.

In an implementation, the first entity and the second entity are one of the following the first entity is a base station, and the second entity is one of a base station, a UE, a location management function (LMF), a distribute unit (DU) and a central unit (CU), the first entity is a LMF and the second entity is a base station, the first entity is a CU, the second entity is one of a DU, a base station and a CU, the first entity is a UE and the second entity is a base station, the first entity is a DU and the second entity is a CU, the first entity is a CU user plane (CU-UP), and the second entity is one of a CU-CP, a base station, a DU and a CU, the first entity is a CU control plane (CU-CP), and the second entity is a CU-UP, the first entity is a core network and the second entity is a base station, or the first entity is an entity with a LMF in a base station, and the second entity is one of a CU-CP, a CU-UP and a DU.

In an implementation, the request includes positioning information related to UE, the response includes one of the following the content and the reason of rejection, or new positioning measurement configuration, and wherein, if the response includes new positioning measurement configuration, receiving a RRC reconfiguration complete message from the UE by the second entity.

In an implementation, the positioning information related to UE includes one or more of a UE measurement ID, measurement configuration, a measurement result, or positioning assistance information related to the positioning of the UE, the new positioning measurement configuration includes one or more of a new UE measurement ID, new measurement configuration, new positioning assistance information, and calculated location information of the UE.

In one implementation, the request is a handover request, and the response is a handover request acknowledgement, or the request is a handover required, and the response is a handover command, or the request is a retrieve UE context request, and the response is a retrieve UE context response.

In accordance with another aspect of the disclosure, a device for positioning information request is provided. The device includes a transceiver configured to transmit and/or receive signals, a memory configured to store data, and a processor configured to perform the method according to various embodiments of the disclosure.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a system architecture of a system architecture evolution (SAE) according to an embodiment of the disclosure;

FIG. 2 is a system architecture according to an embodiment of the disclosure;

FIG. 3 illustrates a positioning architecture and a flow diagram in 5^{th} generation (5G) network according to an embodiment of the disclosure;

FIG. 4 shows a schematic diagram of one aspect of a positioning configuration and reporting method according to an embodiment of the disclosure;

FIG. 5 shows a schematic diagram of another aspect of a positioning configuration and reporting method according to an embodiment of the disclosure;

FIG. 6 shows a schematic diagram of another aspect of a positioning configuration and reporting method according to an embodiment of the disclosure;

FIG. 7 shows a schematic diagram of another aspect of a positioning configuration and reporting method according to an embodiment of the disclosure;

FIG. 8 shows a schematic diagram of another aspect of a positioning configuration and reporting method according to an embodiment of the disclosure;

FIG. 9 shows a schematic diagram of another aspect of a positioning configuration and reporting method according to an embodiment of the disclosure;

FIG. 10 shows a schematic diagram of another aspect of a positioning configuration and reporting method according to an embodiment of the disclosure;

FIG. 11 shows a schematic diagram of another aspect of a positioning configuration and reporting method according to an embodiment of the disclosure;

FIG. 12 shows a schematic diagram of another aspect of a positioning configuration and reporting method according to an embodiment of the disclosure;

FIG. 13 shows a schematic diagram of another aspect of a positioning configuration and reporting method according to an embodiment of the disclosure; and

FIG. 14 shows a simplified block diagram of an example configuration of hardware components of a device for positioning and configuration according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

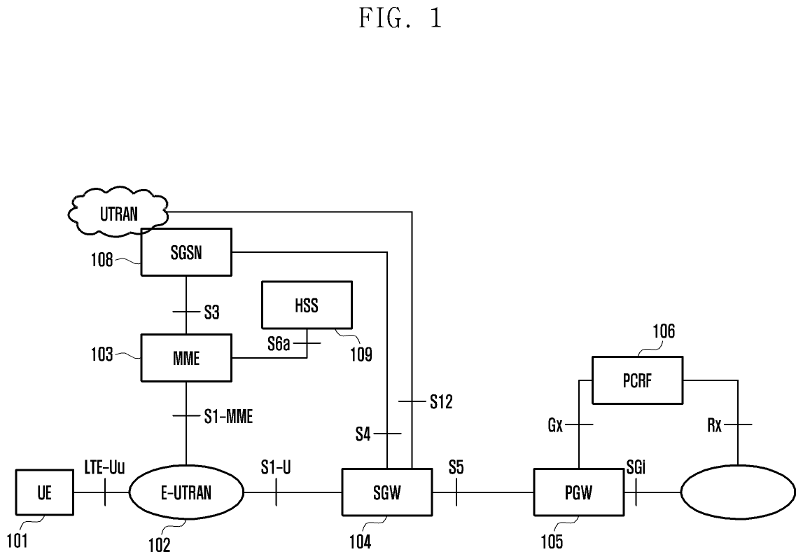

FIGS. 1 to 14 discussed below and various embodiments for describing the principles of the disclosure in this patent document are provided only for illustration, and should not be interpreted as limiting the scope of the disclosure in any way. Those skilled in the art will understand that the principles of the disclosure may be implemented in any properly arranged system or device.

FIG. 1 is a system architecture 100 of system architecture evolution (SAE) according to an embodiment of the disclosure.

Referring to FIG. 1, a user equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, or the like, and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, or the like.

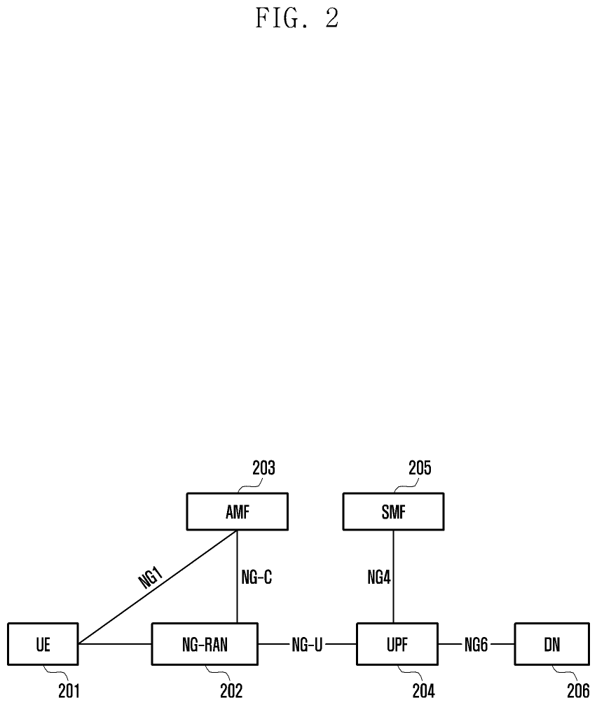

FIG. 2 is a system architecture 200 according to an embodiment of the disclosure. Other embodiments of the system architecture 200 can be used without departing from the scope of the disclosure.

Referring to FIG. 2, a user equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

With a growing demand for the development of wireless technology, in the 5G architecture, the functional modules originally located on the same base station are separated. Among them, some functional modules are closer and closer to users, while others are pool grouped and virtualized for centralized deployment. For example, the base station may be divided into two parts, one of which is a central unit (CU) and the other is a distribute unit (DU). The DU is closer to users, while the CU, far away from antennas, can support multi-antenna connection and improve network performance. A CU may connect multiple DUs, and the functions on the CU can be virtualized. The CU and the DU are connected through F1 interface, which is also called fronthaul interface or fronthaul connection. Functions of radio resource control (RRC) and packet data convergence protocol (PDCP) are implemented on the CU, and functions of radio link control (RLC), media access control (MAC) and physical layer are implemented on the DU.

With the development of mobile communication and diversification of services, user positioning has gradually become one of the most important applications in communication networks, and the requirements for reducing delay and improving accuracy of positioning are getting higher and higher. In many positioning applications, accurate positioning is usually achieved through the combination of various technologies, including 1) global navigation satellite system (GNSS)-based solutions, 2) wireless technology (such as LTE network, Wi-Fi network, terrestrial beacon system, or the like), 3) inertial measurement unit (IMU) or sensor (for example, tracing the user's position based on accelerometer, gyroscope, magnetometer or vertically positioning through atmospheric pressure sensor). These technologies are expected to play an important role in achieving accurate user positioning in the future.

The new wireless technologies (such as rich frequency band resources, larger bandwidth and the multi-antenna technology under large-scale antenna array) used in NG-RAN and flexible deployment methods (such as the use of non-terrestrial radio access networks) provide more freedom and dimensions for enhancing positioning capabilities, enabling more accurate user positioning.

Various embodiments of the disclosure are further described below with reference to the accompanying drawings.

The text and drawings are provided as examples only to help understand the disclosure. They should not be interpreted as limiting the scope of this disclosure in any way. Although certain embodiments and examples have been provided, based on the disclosure herein, it will be apparent to those skilled in the art that various changes may be made to the illustrated embodiments and examples without departing from the scope of this disclosure, and all of the changes are contemplated by this disclosure.

In the embodiments of the disclosure, a component is represented in a singular or plural form. It should be understood, however, that the singular or plural representations are selected appropriately according to the situations presented for convenience of explanation, and the disclosure is not limited to the singular or plural form of the component. Further, the component expressed in the plural form may also imply the singular form, and vice versa.

The positioning configuration and reporting method provided by the disclosure enables the location management function to obtain accurate positioning reference point information in time even when the positioning reference point (an entity sending the positioning reference signal, such as a transmission point (TP), a reception point (RP), a transmission reception point (TRP), an access point, or the like) or the UE moves under the coverage environment of the non-terrestrial radio access network (NTN). This can help the network and the UE to locate the UE more accurately by using richer positioning reference points, more accurate assistance information and more diversified positioning methods. When the UE does not have a positioning capability or the GNSS signal is not strong, and thus the network is needed to assist positioning, the positioning configuration and reporting method provided by this disclosure can make the Location Management Function realize positioning at an entity closer to the UE, thus reducing signaling exchange with the core network, and thus reducing the overall time delay of positioning. In addition, the continuity and accuracy of positioning can still be ensured even when the entities that realize the location management function change frequently. With the positioning configuration and reporting method provided by the disclosure, both the network and the UE can obtain the location information of the UE more quickly under different scenarios, which is beneficial to better realize the wireless network function based on the UE location and improves the resource utilization rate. Meanwhile, it also addresses various issues, for example, related to positioning of UE in non-terrestrial radio access network, and reduces the complexity of system design.

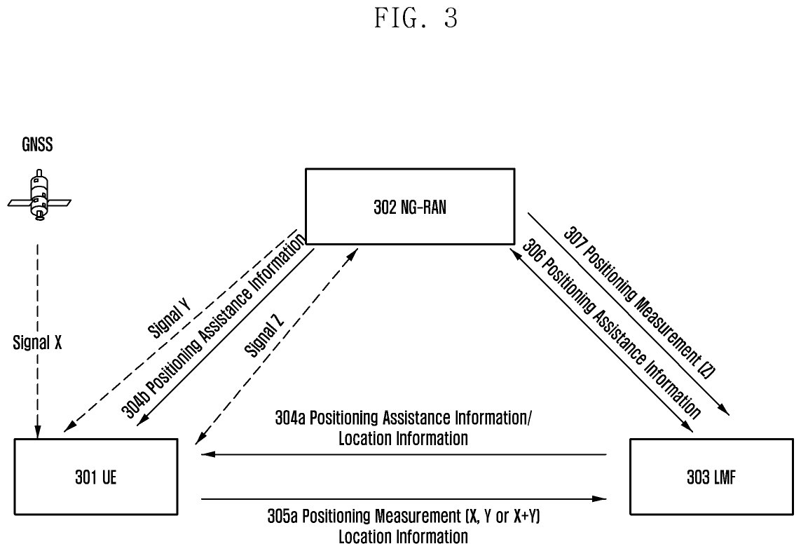

FIG. 3 illustrates a positioning architecture and a flow diagram in a 5G network according to an embodiment of the disclosure.

Referring to FIG. 3, a UE 301 is a terminal device for receiving data. The next generation radio access network (NG-RAN) 302 is a radio access network, and for example, it can be a terrestrial access network (TN) and/or a non-terrestrial radio access network (NTN), such as networks for which the coverage is provided by a satellite, unmanned aerial vehicle and the like. The location management functional (LMF) entity 303 is responsible for managing the overall resource coordination and schedule required to the UE positioning.

When positioning, it is usually necessary to obtain the locations of reference points and collect relevant measurement information. After obtaining the locations of the reference points and the relevant measurement information, the corresponding location information can be calculated (for example, by triangulation, or the like).

The location information of reference points is usually obtained by obtaining positioning assistance information. Generally, the UE and/or the reference point can send a positioning reference signal, and the UE and/or the reference point can obtain relevant measurement information by measuring the downlink/uplink positioning reference signal. The reference points may be different depending on the specific scenario. For example, the reference point may be a base station, such as an antenna or an antenna array in the base station for transmitting or receiving the positioning reference point. For another example, the reference point may also be located on a satellite and/or a ground gateway connected to the satellite.

According to the different entities that evaluate and calculate the location of UE, the positioning may be divided into a UE-based positioning and a location management function (LMF)-based positioning, and NG-RAN can participate in assisting the above two positioning methods.

UE-based positioning means that the UE calculates its own location information according to positioning assistance information and signal measurement results, wherein the positioning assistance information may be sent to the UE by the LMF (304a) or be sent by the NG-RAN according to the instruction of the LMF to the UE (304b). The signal measurement result may be the measurement result obtained by the UE through the received GNSS signal X and/or a signal Y (for example, the downlink positioning reference signal) received from the NG-RAN. After calculating the location information, the UE may report the location information to the LMF (305).

LMF-based positioning means that LMF calculates the location information of the UE according to positioning assistance information and signal measurement results, wherein the positioning assistance information may be sent by the NG-RAN to the LMF (306). The signal measurement result may be a measurement result obtained by the NG-RAN by receiving a signal Z (for example, an uplink positioning reference signal) and is sent to the LMF (307), it may also be a measurement result obtained by the UE according to the GNSS signal X and/or the NG-RAN signal Y, and the measurement result is responded to the LMF (305). After obtaining or calculating the location information of the UE, the LMF may send the location information according to the request in the client side. For example, the client side may be a UE or a core network node.

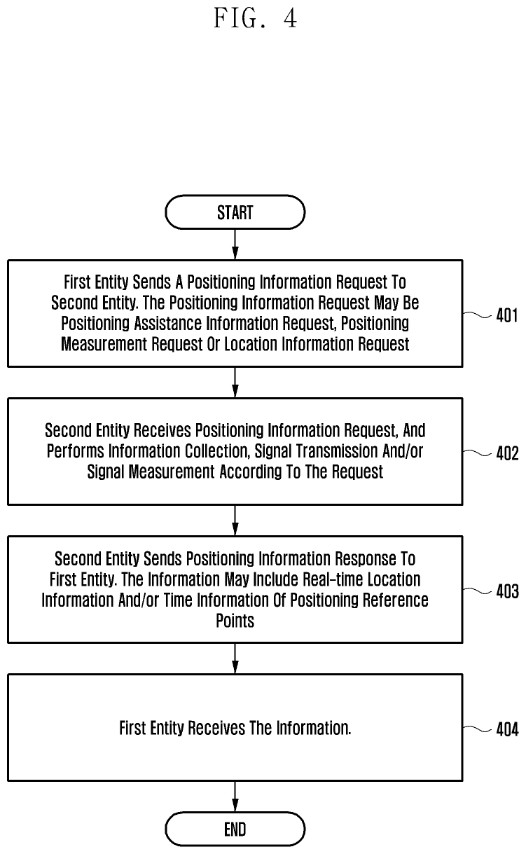

FIG. 4 shows a schematic diagram of one aspect of a positioning configuration and reporting method according to an embodiment of the disclosure. A description of operations that are well known or irrelevant to the key points of this disclosure is omitted here, so as to avoid obscuring the key points of this disclosure.

Generally speaking, the positioning configuration and reporting method according to one aspect of the disclosure includes three stages: positioning assistance information exchange (stage 1), positioning measurement information exchange (stage 2), and location information exchange (stage 3). The general operations of these three stages are similar, so in order to avoid redundancy, the main operations of these three stages will be described together below.

Referring to FIG. 4, the positioning configuration and reporting method according to one aspect of the disclosure comprises the following operations:

At operation 401, sending a positioning information request by a first entity to a second entity. According to various implementations of the disclosure, the first entity may be, for example but not limited to, a LMF, a base station, a CU, a DU, a CU-UP or UE, and the second entity may be, for example but not limited to, a LMF, a base station, a CU, a DU, a CU-CP or UE. It should be noted that other specific entities that can realize the related functions of the first entity and the second entity according to various embodiments of the disclosure are also possible, and they are all expected by the disclosure, and therefore are also covered by the scope of the disclosure. The scope of this disclosure is not limited by the names of various entities or functional modules, or the like. Instead, as long as it is a unit, module, entity, or the like, that implements the functions, methods, or operations according to the embodiments of this disclosure, it is expected by this disclosure, and therefore is covered by the scope of this disclosure.

According to various embodiments of the disclosure, the LMF may be an entity deployed in a core network, a base station or deployed independently of the core network or the base station. According to different stages involved in the method, operation 401 may be divided into the following situations:

In case 1 (corresponding to stage 1), the positioning information request is a positioning assistance information request. According to various embodiments of the disclosure, for example, the request may be a positioning assistance information request sent by the LMF to the base station, a positioning assistance information request sent by the CU to the DU, a positioning assistance information request sent by the UE to the base station, or a positioning assistance information request sent by a first base station to a second base station. The request may include information, such as a location request and a signal (for example, a positioning reference signal) configuration request for a positioning reference point,

In case 2 (corresponding to stage 2), the positioning information request is a positioning measurement request. According to various embodiments of the disclosure, for example, the request may be a positioning measurement request sent by the LMF to the base station, a positioning measurement request sent by the CU to the DU, a positioning measurement request sent by UE to the base station, or a positioning measurement request sent by a first base station to a second base station. The request may include information, such as measurement configuration and a measurement report, wherein the measurement configuration may include measurement of Doppler shift, carrier phase and/or code phase, and

In case 3 (corresponding to stage 3), the positioning information request is a location information request. According to various embodiments of the disclosure, for example, the request may be a location information request sent by the UE to the base station, a location information request sent by the base station to the UE, a location information request sent by the DU to the CU, a location information request sent by the CU-UP to the CU-CP, or a location information request sent by the base station to the LMF. The request is used to request the calculation result of positioning. For example, in various implementations, the request may include a geographic coordinate request, an accuracy request, a positioning source request, or the like.

At operation 402, receiving the positioning information request and performing information collection, signal transmission or signal measurement according to the content of the request by the second entity.

At operation 403, sending positioning information response by the second entity to the first entity, wherein the positioning information response may be one-time response or multiple responses, wherein the multiple responses may be periodic or be triggered by events. The positioning information may be positioning assistance information, positioning measurement information or calculated location information. According to different stages involved in the method, operation 403 may be divided into the following situations:

In the first case (corresponding to stage 1), in response to case 1 in the operation 401, the positioning assistance information is responded by the second entity to the first entity, wherein the information may be positioning assistance information sent by the base station to the LMF, positioning assistance information sent by the DU to the CU, positioning assistance information sent by the base station to the UE, or positioning assistance information sent by the second base station to the first base station. The positioning assistance information may include the following contents:

a reference point information list, wherein the reference point generally refers to the antenna or the antenna array receiving or transmitting the positioning reference signal. In the satellite coverage scenario, the reference point may refer to the antenna or antenna array on the satellite or the antenna or antenna array on the ground gateway connected to the satellite. The reference point may be a transmission receiving point (TRP), a transmission point (TP) or a reception point (RP), and may also be other entities or other forms. Generally multiple reference points are used for locating one UE. Each reference point information listed in the reference point information list may include the following contents:

a reference point ID, used to indicate one positioning reference point of a plurality of reference points corresponding to an entity, and for example, it may be a TRP ID, a TP ID or a RP ID, and

reference point location information, used to indicate the location information of the reference point when it transmits or receives a specific positioning reference signal, may be used to calculate UE location. The reference point location information may include, for example, the following information:

position coordinates, used to indicate the geographical locations of the reference points, may include information, such as latitude and longitude, altitude and time stamp, and

assistance location information: if the reference point has mobility or variability, the assistance location information may include one or more of the following:

trajectory information or trajectory information indication, trajectory information is used to indicate the motion trajectory and corresponding time of the reference point, and may be ephemeris information of the satellite or motion trajectory information of unmanned aerial vehicle along with time stamps, or the like. When the first entity has obtained or configured the trajectory information of each reference point corresponding to the second entity, the first entity can obtain the corresponding trajectory information through the trajectory information indication. The trajectory information indication may be, for example, information about an NTN ID, an NTN beam ID, a satellite ID, a satellite beam ID, or the like,

ground gateway information or ground gateway indication. If the reference point is on the ground gateway connected to the satellite, the ground gateway information is used to indicate the actual geographical location and corresponding time of the reference point on the ground. The ground gateway information may be longitude and latitude information, altitude information, time stamps and other information. When the first entity has obtained or configured the ground gateway connected to the reference point corresponding to the second entity in advance, the first entity may obtain the corresponding ground gateway information through the ground gateway indication. For example, the ground gateway information indication may be information of the ground gateway ID or the time stamps, and

configuration of the positioning measurement reference signal, used to indicate the time-frequency resource configuration information of the reference signal used for positioning at the reference point.

In the second case (corresponding to stage 2), in response to case 2 in the operation 401, positioning measurement information is responded by the second entity to the first entity, wherein the information may be positioning measurement information sent by the base station to the LMF, positioning measurement information sent by the DU to the CU, positioning measurement information sent by the base station to the UE, or positioning measurement information sent by the second base station to the first base station. The positioning measurement information response may include the following contents:

measurement result information, which may include one or more of the following information:

measured values, such as an angle of signal, a delay of signal, a frequency offset and/or a phase offset,

measurement assistance information, such as a channel model, a channel offset or a receiving satellite beam number, or the like, and

location information of the reference point, used to indicate the geographic location of the reference point at the time of measurement, may include information indicating the specific geographic coordinates of the reference point, such as a reference point ID and time stamps, and the reference point ID may be an ID indicating a satellite or an ID indicating a ground gateway.

In the third case (corresponding to stage 3), in response to case 3 in the operation 401, location information is fed back by the second entity to the first entity, wherein the information may be the location information sent by the base station to the UE, the location information sent by the UE to the base station, the location information sent by the CU to the DU, the location information sent by the CU-CP to the CU-UP, or the location information sent by the LMF to the base station. The location information response may include the following contents:

geographic location information of the UE, which may include one or more of the following information:

geographic coordinates, used to indicate the specific geographic location of the UE, may include latitude and longitude information and altitude information,

a time stamp, used to indicate the corresponding time when obtaining the above geographic location,

a motion trajectory, used to indicate the motion trajectory of the UE, may be including multiple historical geographical coordinates and corresponding time stamps, and

moving speed, used to indicate the moving speed of the UE.

At operation 404, the first entity receives the information, and according to the received information, it is divided into the following cases:

in case 1 (corresponding to stage 1), the positioning assistance information is obtained by the first entity. The first entity can save or forward the information according to a request, or formulate positioning policies and/or select positioning reference points according to the assistance information, or query the location information of the positioning reference point at the corresponding time in the positioning assistance information according to the positioning information measured by the first entity itself or the positioning measurement information obtained from other entities in combination with the time information in the corresponding measurement results, so as to calculate the location of the UE,

in case 2 (corresponding to stage 2), the positioning measurement information is obtained by the first entity. The first entity can save or forward the information according to a request, or query the location of the corresponding reference point in the positioning assistance information according to the positioning assistance information obtained in the stage 1 combined with the time information in the measurement result information, so as to calculate the location of the UE, and

in case 3 (corresponding to stage 3), the location information is obtained by the first entity. The location information may refer to the location information of the UE, and the first entity may employ the location information of the UE to implement location-related functions and applications, such as handover, parameter adjustment, beam selection and channel modeling, or the like. More particularly, after entering into the Non-Terrestrial Radio Access Network, the related issues of initial access and mobility management can be addressed by obtaining the location information of the UE.

According to the positioning configuration and reporting method of the embodiment of the disclosure, the entity responsible for the Location Management Function can obtain richer and more accurate positioning reference point information in time under the condition that the positioning reference point is constantly changing, and can implement richer positioning methods, so as to locate the UE more accurately. Meanwhile, the Location Management Function can also realize positioning at an entity closer to the UE, such as radio access nodes, thus reducing signaling exchange with the core network, and thus reducing the overall time delay of positioning. In addition, through this method, each node of the wireless network or the UE can obtain accurate location information of the UE more quickly, and apply the location information to the wireless network functions, so as to improve the utilization rate of system resources, or address some issues brought by new technologies, such as issues like delay compensation or network synchronization caused by the introduction of the Non-Terrestrial Radio Access Network, so as to ensure user experience, reduce the complexity of system design while expanding services by using the NTN, thus increasing the revenue of operators.

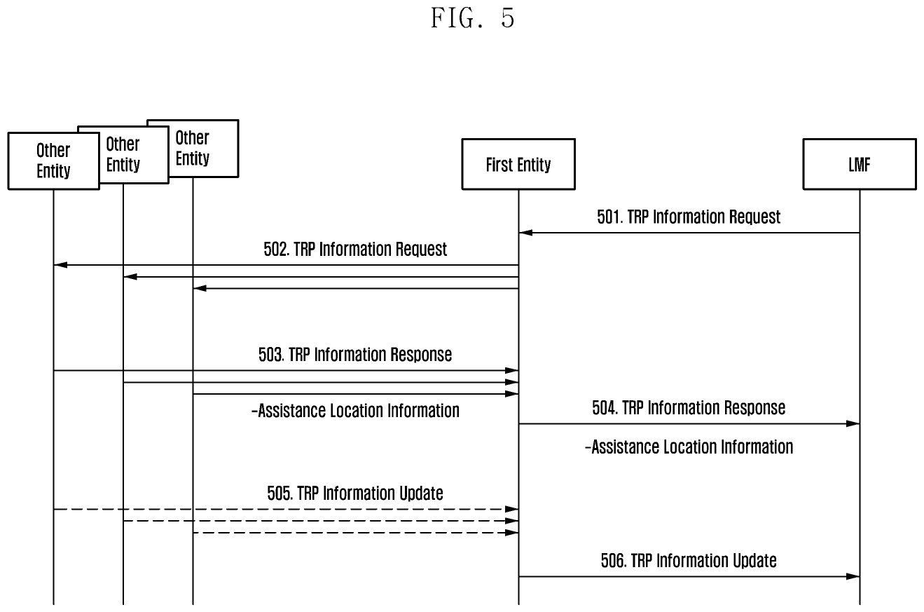

FIG. 5 shows a schematic diagram of another aspect of a positioning configuration and reporting method according to an embodiment of the disclosure. A description of operations that are well known or irrelevant to the key points of this disclosure is omitted here, so as to avoid obscuring the key points of this disclosure.

Referring to FIG. 5, the method comprises the following operations:

At operation 501, sending a request message for reference point (e.g., TRP, which is described as a reference point for convenience of description in the following, but it should be noted that this is not intended to be limiting) information by an entity with a Location Management Function (e.g., LMF, which is described as an example for convenience of description in the following, but it should be noted that this is not intended to be limiting) to a first entity. The request message may include the location information of the TRP and the method of information response, wherein the method may be one-time response, periodic response or event-based response. The first entity may be a base station or a CU. The LMF may be deployed on a core network or a base station. If the LMF is deployed on the base station, it may be deployed in a CU, a DU or another independent entity.

The first entity receives the request message. When the base station is in a split architecture, the following operations will be performed:

At operation 502, sending (e.g., forwarding) a TRP information request message by the first entity to one or more other entities, and the content of the request message is as described in the operation 501, which will not be described here. The other entities may be a DU in a split architecture.

The other entities receive the TRP information request message.

At operation 503, the TRP information (for example, the satellite trajectory or connection information of the ground gateway) is collected by the other entities, and the TRP information is sent to the first entity through a TRP information response message. The TRP information response message may include the following information:

a TRP ID, used to indicate a specific positioning reference point corresponding to the base station. The TRP may be on the satellite or on the ground. If the TRP is on a satellite, the TRP ID can indicate the specific antenna or antenna array on a specific satellite. If the TRP is on the ground gateway, the TRP ID can indicate the antenna or antenna array on the ground gateway connected to the satellite, and

TRP location information, used to indicate the location information of TRP when sending or receiving a specific positioning reference signal, and to calculate the location of the UE. The TRP location information may specifically include the following information:

assistance location information: if the TRP has mobility and variability, the content of the assistance location information is different according to the following two situations, as follows:

In case 1, if the first entity does not pre-configure or obtain information about the trajectory of TRP and the ground gateway, the assistance information may include the following contents:

trajectory information, used to indicate the motion trajectory of the TRP and the corresponding time. For example, it may be ephemeris information of the satellite or motion trajectory information of the unmanned aerial vehicle plus the time stamps, or the like.

ground gateway information, used to indicate the actual geographical location of the TRP on the ground and the corresponding time if the TRP is on the ground gateway connected to the satellite. For example, it can be longitude and latitude information, altitude information, time stamps and the like.

In case 2, if the first entity has configured in advance or has obtained trajectory information and ground gateway information, the assistance location information may include:

a satellite ID, used to indicate the specific satellite where the TRP is located. For example, it may be a satellite ID, a satellite beam ID or other forms, and the first entity may query the motion trajectory of the TRP according to the satellite ID,

a ground gateway ID, used to indicate the ground gateway where the TRP is located if the TRP is on the ground gateway connected to the satellite, and the first entity can query the actual geographical location of the TRP and the corresponding time according to the ground gateway ID (for example, longitude and latitude information, altitude information, time stamps and the like).

The first entity receives the TRP information response message.

At operation 504, after the first entity receives all the TRP information response messages from all the above one or more entities, the TRP information response messages are sent by the first entity to the LMF. The response messages include the TRP response information from one or more other entities mentioned above, for example, it may include assistance location information of each TRP. The specific content of the TRP information response message is as described in the operation 503, which is not repeated here to avoid redundancy.

At operation 505, if the location of the TRP changes (for example, the satellite trajectory changes or the ground gateway changes) or the TRP information update period comes, the TRP information update is sent by other entities to the first entity. The specific content of the TRP information update is as described in the operation 503, and will not be repeated here to avoid redundancy.

At operation 506, if the first entity receives the TRP information update from other entities, a TRP information update message is sent by the first entity to the LMF, and the message carries the contents of the TRP information update in the operation 505.

The first entity or the LMF, after obtaining information about the TRP (e.g., assistance location information), can obtain accurate TRP location information at the time corresponding to the measurement result according to the ID information and the time information in the positioning measurement report to be described later, and put the accurate TRP location information and the measurement result into the location calculation of the UE, so as to improve the accuracy of the UE location calculation.

According to the positioning configuration and reporting method of the embodiment of the disclosure, the entity responsible for the Location Management Function can obtain richer and more accurate positioning reference point information in time under the condition that the positioning reference point is constantly changing (for example, but not limited to, the location of the reference point is changing, the reference point is changing between different nodes, or the like), for example, under the scenario of the coverage by the Non-Terrestrial Radio Access Network satellite, so as to locate the UE more accurately. After obtaining more accurate location information of the UE, the network or the UE can apply the location information to the location-related wireless network functions, and address the access issues and mobility issues brought by the introduction of the NTN, thus ensuring user experience and reducing the complexity of system design while expanding services by using the NTN so as to increase the revenue of operators.

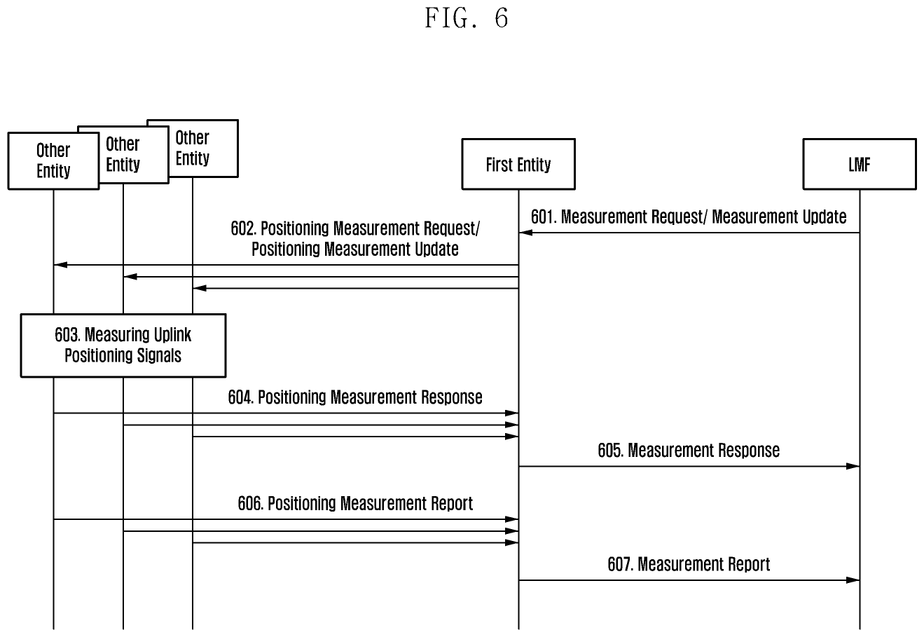

FIG. 6 shows a schematic diagram of another aspect of a positioning configuration and reporting method according to an embodiment of the disclosure. A description of operations unrelated to the disclosure is omitted here.

Referring to FIG. 6, the method includes the following operations:

At operation 601, sending a measurement request message or a measurement update message by the LMF to a first entity, wherein the message includes the configuration of the UE positioning reference signal to be measured and measurement type. The measurement type may include at least one of the following types:

Doppler measurement, used to instruct the receiver to measure the Doppler shift of the received signal, and is suitable for signal transceivers moving in high speed, such as LEO and MEO satellites, or the like,

carrier phase measurement, used to instruct the receiver to measure the carrier phase observation value of the received signal or its difference observation value, and

code phase measurement, used to instruct the receiver to measure the code phase observation value of the received signal or its difference observation value.

In an implementation, the first entity may be a base station or a CU. The LMF may be deployed on a core network or a base station. If the LMF is deployed on the base station, it may be deployed on a CU, a DU or another independent entity.

The first entity receives the message. Under the split architecture with the CU and the DU, the first entity is, for example, a CU, and the method further comprises the following operations:

At operation 602, sending a positioning measurement request message or a positioning measurement update message by the first entity to one or more other entities. The other entities may be a DU. The content that can be included in the message is as described in the operation 601. The message is received by other entities.

At operation 603, after receiving the positioning measurement request message sent by the first entity, other entities start to measure the corresponding positioning reference signal according to the measurement type and the configuration, and generate measurement results.

At operation 604, sending a positioning measurement response message by other entities to the first entity, wherein the message may include the following information:

measurement result information, which may be one or more of the following information:

a measurement value, which may include a Doppler shift value, a carrier phase measurement value, a code phase measurement value, or the like,

measurement assistance information, such as a channel model, channel offset, a satellite beam ID, or the like, and

access point information, used to indicate the geographical location of the positioning reference point at the time of measurement, may be information about the satellite ID and/or the ID of the ground gateway connected to the satellite.

At operation 605, sending a measurement response message by the first entity to the LMF, wherein the message includes positioning measurement response from other entities, and the specific contents included in the message are as described in the operation 604.

At operation 606, if other entities provide a new measurement result according to the configuration (for example, if the configuration of the UE positioning reference signal to be measured included in the message described in the operation 601 or operation 602 indicates periodic measurement/update or event-triggered measurement/update), a positioning measurement report message is sent by the other entities to the first entity, wherein the message may include the newly measured positioning measurement result. The positioning measurement result may include the same contents as those included in the positioning measurement response message in the operation 604.

At operation 607, after the new positioning measurement result from other entities is received by the first entity, sending a measurement report message by the first entity to the LMF, wherein the message includes the new positioning measurement result and may include the same contents as those in the positioning measurement response message described in the operation 604.

After receiving a plurality of positioning measurement results, the first entity or the LMF may save or forward the measurement results to other entities with the Location Management Function, such as a core network node, a base station, an entity in the base station, or UE. If the TRP has mobility, such as in a satellite coverage scenario, after receiving multiple measurement results, the specific location of TRP corresponding to each measurement result can be obtained according to the time information in the measurement results and the previously obtained TRP assistance location information, and the specific location of TRP is used to calculate the location of the UE. The LMF can also use more diversified positioning methods according to the richer measurement dimensions in the measurement results, so as to locate the UE more accurately.

According to the positioning configuration and reporting method of the embodiment of the disclosure, the entity responsible for the Location Management Function can obtain richer and more accurate measurement results and the accurate location of the positioning reference point corresponding to the measurement results in time under the condition that the positioning reference point is constantly changing, such as in the non-terrestrial radio access network (NTN) satellite coverage scenario, so as to locate the UE more accurately. After the network or the UE obtains more accurate location information of the UE, the location information can be applied to the location-related wireless network functions to address the access issues and mobility issues brought by the introduction of the NTN, so that the NTN can be used to expand services, while ensuring user experience, reducing the complexity of system design, and thus increasing the revenue of operators.

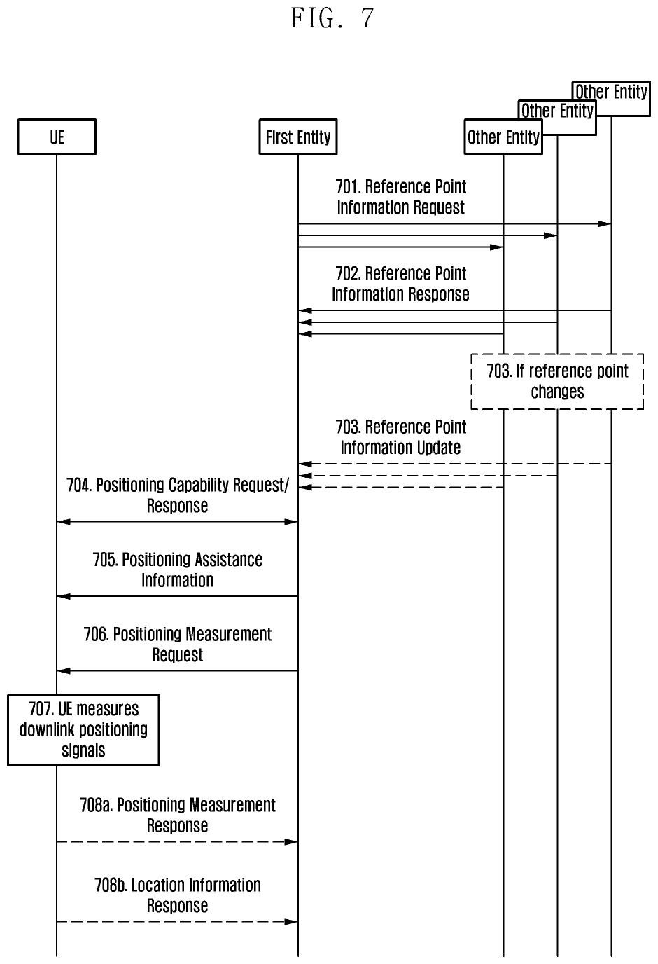

FIG. 7 shows a schematic diagram an example of another aspect of a positioning configuration and reporting method according to an embodiment of the disclosure. A description of operations unrelated to the disclosure is omitted here.

Referring to FIG. 7, the method includes the following operations:

At operation 701, sending a reference point information request by a first entity to one or more other entities.

In various implementations, the first entity may be a base station, a CU or a CU-CP, and other entities may be a base station and a DU, wherein the other entities refer to the entities where the signal reference point selected by the first entity for positioning measurement locate, and may be one or more entities. The first entity and other entities may be in a terrestrial radio access network (TN) or a Non-terrestrial radio access network (NTN).

According to the embodiment of the disclosure, the first entity has a location management function, which has been successfully registered on the location management function in the core network, and has the ability to initiate a positioning information request and a positioning measurement request to the UE or other entities. The Location Management Function on the first entity also has the ability to collect all positioning measurement results and to calculate location information of the UE according to the positioning information and measurement results.

The reference point information request may include contents as described in the TRP information request in the operation 501.

The reference point information request may be sent in an Xn establishment request message or another new message, as a non-limiting example, such as a reference point information request message, a positioning assistance information request message or a TRP information request message. The message may use a Xn protocol, or a NRPPa protocol encapsulated in the Xn protocol, but is not limited to this. In addition, it should be understood that with the update and change of communication technology, the specific name of the Xn protocol may change (for example, X2 in 4G). But these are within the scope of this disclosure. Therefore, it should be understood that the message may also use any other protocol for the interface between radio access nodes, and is not limited to the Xn protocol.

At operation 702, sending a reference point information response by other entities to the first entity. The reference point information response may include the following information:

a reference point list indicating information of a plurality of reference points, each item of reference point information may include one or more of the following information:

a reference point ID, and for example, it may be a TRP ID or a TP ID

cell information, an ID of a cell where the access point is located

synchronization information, synchronization information of signals on the access point

configuration of the positioning reference signals, configuration information of positioning reference signals on access point

reference point location information

location coordinates and time stamps

assistance location information:

trajectory information or trajectory information indication: directly or indirectly indicates the motion trajectory of the reference point or the ephemeris information and the time stamps

ground gateway information or ground gateway indication: directly or indirectly indicates the geographical location of the ground gateway and the time stamps

configuration of the positioning measurement reference signals, used to indicate the time-frequency resource information of the reference signals used for positioning at the reference point.

Details of the reference point information response are as described in the first case of the operation 403.

The reference point information response may be sent in a Xn establishment response message or a new message, wherein the new massage is, for example, a reference point information response message, a positioning assistance information response message or a TRP information response message, and the message may use a Xn protocol or a NRPPa protocol encapsulated in the Xn protocol, but is not limited to this.

At operation 703, if the reference point in other entities changes, such as the satellite in the NTN or the ground gateway connected to the satellite changes, sending the reference point information update by the other entities to the first entity. The reference point information may include contents as described in the operation 702.

The reference point information may be sent in a NG-RAN node configuration update message or a new message, wherein the new message is, for example, a reference point information update message, a positioning assistance information update message or a TRP information update message, or the like.

At operation 704, sending a positioning capability request by the first entity to the UE, and sending a positioning capability response by the UE to the first entity.

The positioning capability request may be transmitted in a RRC reconfiguration message or a positioning capability request message.

The positioning capability response may be transmitted in a RRC reconfiguration complete message, a positioning capability report message or a positioning capability response message.

At operation 705, sending positioning assistance information by the first entity to the UE according to the positioning capability of the UE, wherein the positioning assistance information includes downlink positioning reference signal configuration of the serving cell and neighboring cells, and may also include positioning assistance information of other entities collected by the first entity, such as location information of the reference point or the TRP, and the location information may include assistance location information, such as the moving trajectory of the reference point or the TRP and/or information of the ground gateway, as detailed in the operation 702. The positioning assistance information may be transmitted in a positioning system message, a RRC reconfiguration message or a message providing assistance information.

At operation 706, sending a positioning measurement request by the first entity to the UE. The positioning measurement request may include the following information:

a request type: it may be at least one of measurement, measurement & evaluation. Measurement means that the UE only needs to perform measurement according to the configuration and reports the measurement result to the first entity, measurement & evaluation means that the UE can directly evaluate and calculate its location according to the measurement result and assistance information after performing the measurement according to the configuration, and

measurement configuration, including the following:

signal configuration, configuration of a signal to be measured, and the specific time-frequency resource location,

measurement contents: they may include information, such as signal delay, time difference, arrival angle, carrier phase, Doppler shift, signal strength, or the like, and the specific measurement content is related to the positioning method, and

report configuration, it may be a periodic report or an event-based report. The event is, for example, a cell change, an evaluated location change exceeding a certain threshold, or a measurement information change exceeding a certain threshold, or the like.

The positioning measurement request may be transmitted by a RRC protocol, such as a RRC reconfiguration message, a positioning measurement request message or a request positioning information message, but is not limited to these.

At operation 707, measuring the positioning reference signal by the UE according to the configuration information in the operation 706.

If the request type is measurement & evaluation, the UE can directly use the measurement result and the previously received assistance information to evaluate and calculate the location of the UE.

At operation 708a, if the UE only measures the positioning information in the operation 707, sending a positioning measurement response by the UE to the first entity. The positioning measurement response may be one-time response or multiple responses, and may include one or more of the following information:

reference point information, such as a reference point ID or the location information of the reference point,

measurement values, such as time delay, direction angle, phase, frequency offset, or the like, and

time information, such as the time stamp at the time of measurement.

In various implementations, for example, the positioning measurement response may be transmitted in a measurement report message, a positioning measurement report message or a response positioning information message. The message may use a RRC protocol.

The first entity receives all positioning measurement response and calculates the location of the UE according to the assistance information.

At operation 708b, if the UE evaluates and calculates the location of the UE after the measurement is completed in the operation 707, sending a location information response by the UE to the first entity. The location information response may be one-time or multiple responses, and may include specific longitude and latitude, altitude, time stamps and/or calculation accuracy of the UE, or the like.

In various implementations, for example, the location information response may be transmitted in a measurement report message, a positioning measurement report message, a response positioning information message or a location information response message. The message may use a RRC protocol.

The response information involved in the operation 708a and the operation 708b may be sent using the same message, or may be sent separately using different messages.

The first entity or the UE may calculate the location of the UE through the measurement result or directly obtain the location information of the UE. The first entity or the UE may use the location information of the UE for its own wireless network functions, or may send the location information of the UE to other entities according to the request, so that other entities can use location-related functions and applications. The other entities may be a base station, a DU or a CU-CP, or the like.

According to the positioning and configuration method of the embodiment of the disclosure, the Location Management Function can be realized at an entity closer to the UE, thus reducing the signaling exchange with the core network and the positioning delay in the positioning procedures. The method can provide more diversified positioning reference points, positioning assistance information and positioning methods under the environment of Non-Terrestrial Radio Access Network. In addition, in the scenario where the reference point moves, the method can also provide accurate reference point information, so as to locate the UE more quickly and more accurately. After the network or the UE obtains more accurate location information of the UE, the location information can be applied to the location-related wireless network functions to address the access issues and mobility issues brought by the introduction of the NTN, so that the NTN can be used to expand services, while ensuring user experience, reducing the complexity of system design, and thus increasing the revenue of operators.

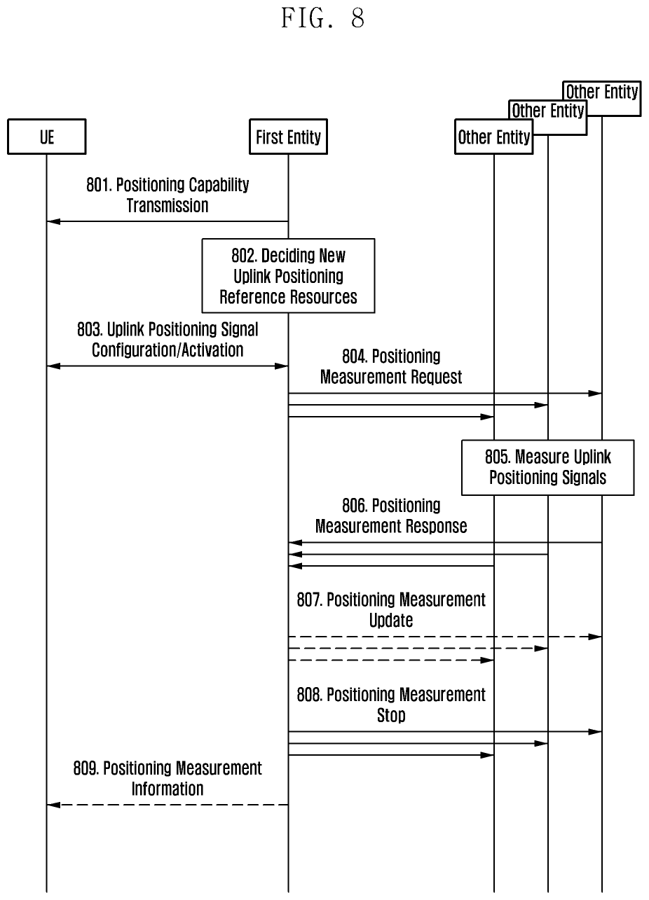

FIG. 8 shows a schematic diagram of a positioning and configuration method according to an embodiment of the disclosure. A description of operations unrelated to the disclosure is omitted here.

Referring to FIG. 8, the method includes the following operations:

At operation 801, transmitting the positioning capability between the UE and the first entity, as described in the operation 704. The first entity may be, for example, a base station, a CU or a CU-CP.

The first entity has a location management function, which has been successfully registered on the Location Management Function in the core network, and has the ability to initiate a positioning information request and a positioning measurement request to the UE or other entities. The location management function on the first entity also has the ability to collect all positioning measurement results and to calculate location information of the UE according to the positioning information and measurement results.

At operation 802, deciding the allocation of the resources of the uplink positioning reference signal to the UE by the first entity according to the UE capability.

At operation 803, sending the uplink positioning signal configuration to the UE and activating the configuration, by the first entity. After receiving the configuration information and the activation instruction, the UE starts to send the uplink positioning reference signal on specific locations.

At operation 804, sending a positioning measurement request by the first entity to one or more other entities. The other entities may be, for example, a base station or a CU, and refer to one or more entities where the reference points selected by the first entity for positioning measurement. The first entity and other entities may be a TN or a NTN.

The positioning measurement request may include contents as described in the operation 706.

In various embodiments, for example, the positioning measurement request may be transmitted in a positioning information request message or a positioning measurement request message, wherein the message may use a Xn protocol or a NRPPa protocol encapsulated in the Xn protocol, but is not limited to this.

At operation 805, after receiving the positioning measurement request in the operation 804, other entities start to measure UE uplink positioning reference signals according to the configuration in the positioning measurement request.

At operation 806, sending positioning measurement responses by other entities to the first entity. The first entity receives the report information and calculates the location of the UE according to all the response information and assistance information. The positioning measurement response may include the contents as described in the operation 708.

In various embodiments, for example, the positioning measurement response may be transmitted in a positioning measurement response message or a positioning measurement report message, wherein the message may use a Xn protocol or a NRPPa protocol encapsulated in the Xn protocol, but is not limited to this.

At operation 807, if the positioning measurement configuration changes, sending a positioning measurement update by the first entity to other entities, and the specific contents of the positioning measurement update are as described in the operation 706.

In various embodiments, for example, the positioning measurement update may be transmitted in a positioning measurement update message or a positioning measurement reconfiguration message. The message may use a Xn protocol, or a NRPPa protocol encapsulated in the Xn protocol, but is not limited to this.

At operation 808, if the positioning ends, sending the positioning measurement stop by the first entity to other entities to inform other entities to stop measuring.

In various embodiments, for example, the positioning measurement stop may be transmitted in a positioning measurement update message or a positioning measurement stop message. The message may use a Xn protocol, or a NRPPa protocol encapsulated in the Xn protocol, but is not limited to this.

At operation 809, if the UE has a location computing capability, and wants to obtain more positioning computing resources, the first entity may send positioning measurement information to the UE, wherein the information includes all positioning measurement results of the UE within a certain time received by the first entity. The specific contents of the positioning measurement information are as described in the operation 708a.

After obtaining enough positioning measurement information, the UE or the base station can calculate the geographical location of the UE according to the assistance information. The UE or the network may directly apply the location information to its own functions or may send it to other entities or functions, so that the network can realize more location-based functions and applications, thus improving resource utilization rate and improving user satisfaction. After the network or the UE obtains more accurate location information of the UE, the access issues and mobility issues brought by the introduction of the NTN can be addressed, so that the NTN can be used to expand services, while ensuring user experience, reducing the complexity of system design, and thus increasing the revenue of operators.

According to the positioning and configuration method of the embodiment of the disclosure, the Location Management Function can be realized on an entity closer to the UE, thus reducing the signaling exchange with the core network and the positioning delay in the positioning procedures. The method can provide more diversified positioning reference points, positioning assistance information and positioning methods under the environment of Non-Terrestrial Radio Access Network. In addition, in the scenario where the reference point moves, the method can also provide accurate reference point information, so as to locate the UE more quickly and more accurately. After the network or the UE obtains more accurate location information of the UE, the location information can be applied to the location-related wireless network functions to address the access issues and mobility issues brought by the introduction of the NTN, so that the NTN can be used to expand services, while ensuring user experience, reducing the complexity of system design, and thus increasing the revenue of operators.

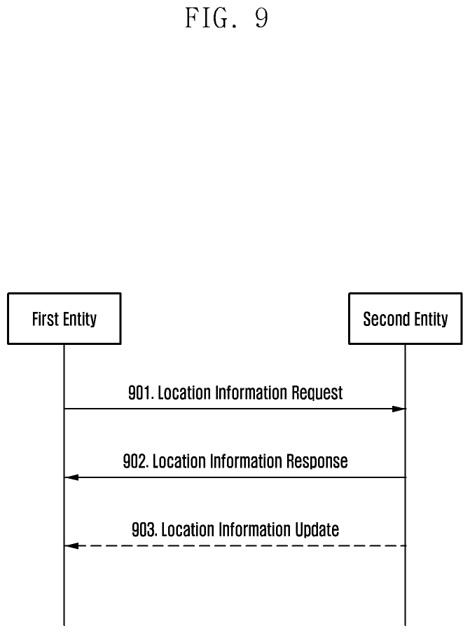

FIG. 9 shows a schematic diagram of a positioning and configuration method according to an embodiment of the disclosure. A description of operations unrelated to the disclosure is omitted here.

Referring to FIG. 9, the method includes the following operations:

FIG. 9 illustrates an operation of providing a positioning capability indication by a second entity to a first entity, i.e., indicating whether it has a LMF capability. In various implementations, for example, the first entity may be UE, a DU, a CU-UP or a base station, and the corresponding second entity may be a core network, a base station, an entity with a LMF in the base station, a CU, a CU-CP or UE. In one implementation, the indication may be obtained from specific information in some messages, and the specific information is, for example, LMF support indication information, in one implementation, the indication may also be that the first entity infers that the second entity has LMF capability from the received positioning request related message. The positioning request related message may be transmitted in the following messages, for example:

a positioning capability request message sent by the base station to the UE,

a F1 interface establishment response message, a positioning measurement request message sent by the CU to the DU,

a GNB-CU-CP E1 interface establishment request message, a GNB-CU-UP E1 interface establishment response message sent by the CU-CP to the CU-UP,

a positioning capability response message sent by the UE to the base station,

a NG interface establishment response message, a positioning measurement request message sent by the core network to the base station, and

an interface establishment request message, an interface establishment response message, a positioning measurement request message, or the like, initiated by an entity with a LMF in the base station to other entities in the base station, wherein the other entities may be a CU-CP, a CU-UP or a DU.

At operation 901, sending a location information request by the first entity to the second entity. According to the first entity and the second entity, the specific scenario is as follows:

if the base station has a LMF capability, i.e., it can have the location information of the UE, then the UE can initiate a location information request to the base station,

if the CU has a LMF capability, i.e., it can have the location information of the UE, then the DU can initiate a location information request to the CU,

if the CU-CP has a LMF capability, i.e., it can have the location information of the UE, then the CU-UP can initiate a location information request to the CU-CP,

if the core network has a LMF capability, then the base station can initiate a location information request to the LMF, and

if the base station has a LMF capability and the entity with the LMF capability is an entity deployed independently of the CU-CP, the CU-UP or the DU, then the CU-CP, the CU-UP or the DU initiates a location information request to the entity.

The location information request may include the following contents:

a UE ID, used to identify the UE that needs to request location information; and

a response type, which may be periodic response or event-based response. The events are, for example, a cell change, an evaluated location change exceeding a certain threshold, or a measurement information change exceeding a certain threshold, or the like.

As a non-limiting example, for example, the location information request may be transmitted in the following messages:

a location information request message or a positioning information request message sent by the UE to the base station,

a location information request message or a positioning information request message sent by the DU to the CU,

a RRC reconfiguration message, a location information request message or a positioning information request message sent by the base station to the UE,

a location information request message sent by the base station to the core network, and

a location information request message sent by other entities of the base station to entities with the LMF in the base station.

At operation 902, sending a location information response by the second entity to the first entity. The second entity can calculate the location of the UE through its own Location Management Function combined with the positioning measurement results and assistance information, or can obtain the location information of the UE through other entities.

The location information response may include the following contents:

a UE ID, used to identify the UE that feeds back the location information.

an acquisition failure indication, used to indicate that the request for location information has failed this time

failure reason, used to indicate the reason for failure

a location information list, used to indicate location information at one or more different times, and may specifically include the following information:

location coordinates, used to indicate the specific location coordinates of the UE, including latitude and longitude and altitude information.

time information indicating the specific time corresponding to the above-mentioned location coordinates

location accuracy, used to indicate the positioning accuracy of the above-mentioned location coordinates

positioning source, used to indicate the positioning source of the above-mentioned location coordinates

moving speed information: used to indicate the moving speed of the UE, so that the first entity can judge the moving trajectory of the UE in combination with the location information list.

As a non-limiting example, for example, the location information response may be transmitted in the following messages:

a location information response message or a positioning information response message sent by the base station to the UE,

a location information response message or a positioning information response message sent by the CU to the DU,

a location report message, a location information report message or a positioning information report message sent by the UE to the base station,

a location response message or a positioning information report message sent by the core network to the base station.

a location response message or a positioning information report message sent by the entity with the LMF in the base station to other entities (CU-CP, CU-UP or DU) in the base station,

At operation 903, if the location information changes or the update period comes, sending the location information update by the second entity to the first entity. The location information update includes, for example, the information for requesting the latest location of the UE, and the specific contents are as described in the operation 902.

As a non-limiting example, for example, the location information update may be transmitted in the following messages:

a location information update message or a positioning information update message sent by the base station to the UE,

a location information update message or a positioning information update message sent by the CU to the DU,

a location report message, a location information report message or a positioning information report message sent by the UE to the base station,

a location information update message or a positioning information update message sent by the core network to the base station.

a location information update message or a positioning information update message sent by the entity with the LMF in the base station to other entities (CU-CP, CU-UP or DU) in the base station,

After its own location information is obtained by the UE, it can be used to assist GNSS positioning, navigation or other location-related applications and the realization of wireless functions, and for example, under the NTN environment, the process of time delay compensation or location-based handover, or the like, can be realized by the UE itself.

After the location information of the UE is obtained by the DU, it can be used for channel estimation and MIMO modeling, which is beneficial to signal transmission and reception, and to improve channel reliability and the resource utilization rate.

After the location information is obtained by the CU-UP, the location information can be applied to location-related wireless network functions.

After the location information of the UE is obtained by the base station or the entity in the base station (CU-CP, CU-UP or DU), it can be used for channel estimation, MIMO modeling, delay compensation and location-based mobility management, which can improve channel reliability and the resource utilization rate, and address various issues under the NTN environment through, for example, the mobility management function based on the location of the UE, or the like.

According to the positioning and configuration method of the embodiment of the disclosure, when the UE does not have the positioning capability or has a weak positioning capability, it can obtain its own location information through the network, so as to support and implement more location-related functions and applications, such as navigation and location-based handover.

With this method, the functions or entities in the base station can obtain the real-time location information of the UE, and use the obtained location information in the process of resource scheduling or channel estimation, which is beneficial to improve the efficiency of air interface resource scheduling and modeling of beamforming under large-scale multi-antenna arrays, so as to improve the resource utilization rate and reduce the cost.

With this method, the location information of the UE can be obtained when the base station does not have the positioning capability, so as to better achieve functions, such as resource management and mobility management, thus improving network performance, user experience and satisfaction.

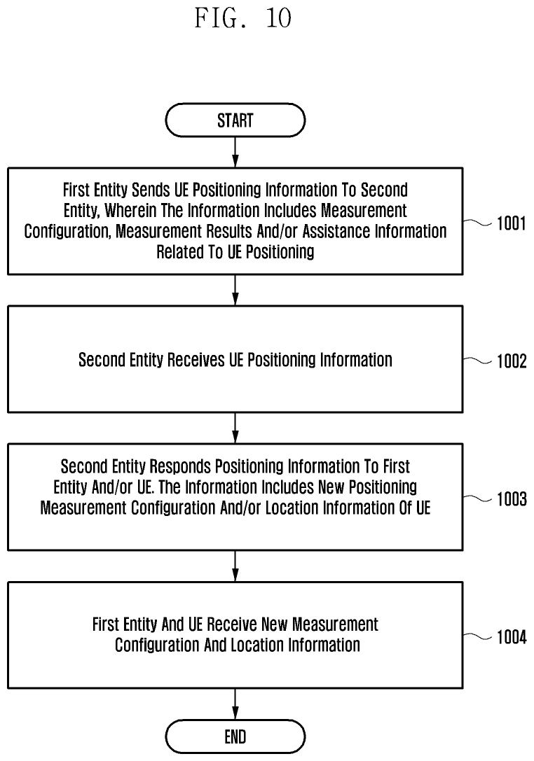

FIG. 10 shows a schematic diagram of a positioning and configuration method according to an embodiment of the disclosure. A description of operations unrelated to the disclosure is omitted here.

Referring to FIG. 10, the method includes the following operations:

At operation 1001, sending positioning information of UE by a first entity to a second entity. For example, the first entity may be a base station, and the first entity has a Location Management Function for the UE. The second entity may be a base station or a core network, and the core network may be an access management entity (AMF). The positioning information of the UE refers to the configuration related to the UE positioning, measurement results of the UE positioning and/or assistance information of the positioning. The measurement results of the UE positioning include the measurement results obtained by the first entity itself and the measurement results received from other nodes.

The main reason why the first entity sends UE positioning information to the second entity is that the serving node of the UE has changed from the first entity to the second entity, so the first entity needs to initiate redirection of the Location Management Function of the UE to the second entity, so as to migrate the Location Management Function responsible for the UE from the first entity to the second entity.

At operation 1002, the second entity receives the positioning information of the UE, and determines whether the redirection of the Location Management Function of the UE is successful according to the capability information of the second entity. If successful, the second entity needs to prepare new positioning resources for the UE according to the specific situation.

At operation 1003, sending positioning information response by the second entity to the first entity and/or the UE, wherein the response may include information, such as the redirection result of the Location Management Function, the new positioning configuration, and the evaluated and calculated location of the UE.

At operation 1004, if the redirection of the Location Management Function is successful, the first entity and/or the UE receives new positioning configuration information and location information of the UE, and starts a new round of positioning measurement.

In this way, after the entity serving the UE changes, the new serving entity can still provide the location management Function for the UE, and has historical location management information, so that more positioning measurement information and location information can be obtained in time for calculating the location of the UE.

According to the positioning and configuration method of the embodiment of the disclosure, the Location Management Function can be realized on an entity closer to the UE, thus reducing the signaling exchange with the core network and the positioning delay in the positioning procedures. Meanwhile, the method can also ensure the continuity and integrity of positioning under the scenario that the entity where the location management Function of the serving the UE is located changes frequently, especially under the situation that the serving base station in the non-terrestrial radio access network changes frequently, and at the same time, it also provides richer positioning reference resources, so as to locate the UE more accurately. In addition, through this method, the network or the UE can obtain the accurate location information of the UE more quickly, and apply the location information to wireless network functions to improve the utilization rate of system resources or address some issues brought by new technologies, such as delay compensation or network synchronization caused by the introduction of the Non-Terrestrial Radio Access Network.

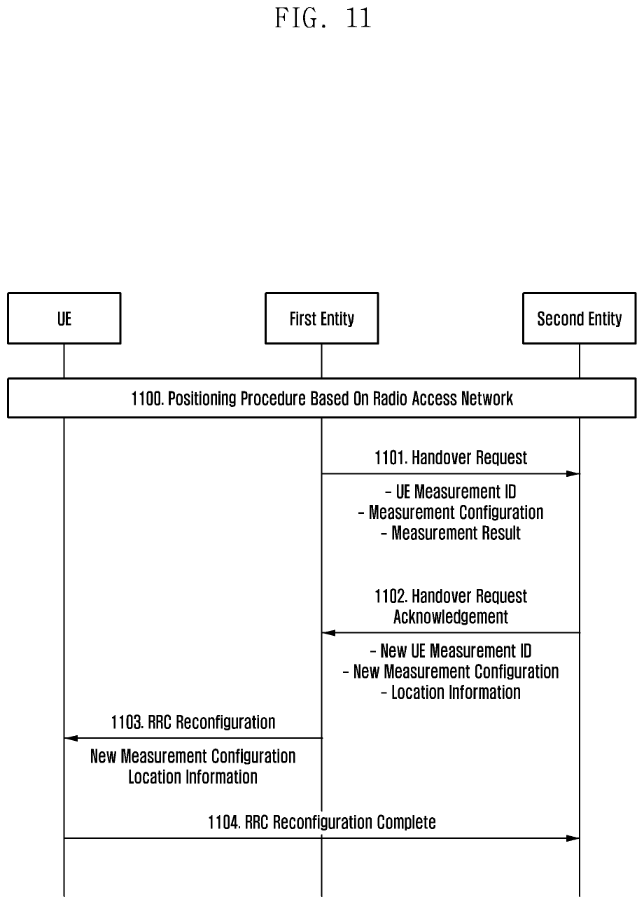

FIG. 11 shows a schematic diagram of a positioning and configuration method according to an embodiment of the disclosure. A description of operations unrelated to the disclosure is omitted here.

Referring to FIG. 11, the method includes the following operations:

At operation 1100, initiating a positioning procedure based on the radio access network by a first entity to the UE and/or other entities. For example, the first entity and other entities may be base stations, and the other entities may include a second entity. The first entity may have a positioning measurement result for the UE, and the measurement result may be a measurement result from the first entity or other entities.

At operation 1101, if the first entity decides to handover the UE from the first entity to the second entity, sending a handover request message by the first entity to the second entity, and the message includes all positioning information related to the UE, so as to redirect the entity responsible for the Location Management Function of the UE. As a non-limiting example, the positioning information may specifically include the following contents:

a UE measurement ID, used to indicate a specific positioning measurement configuration of the UE,

UE measurement configuration, which may include the following:

uplink measurement configuration information, such as uplink positioning reference signal configuration and other information,

downlink measurement configuration information, such as an ID of the downlink reference point to be measured and the corresponding reference signal configuration,

positioning assistance information, the details of which are described in the operation 702, and

a UE location measurement result, the details of which are as described in the operation 708a/708b.

At operation 1102, sending a handover request acknowledgement message by the second entity to the first entity. After receiving the positioning information sent by the first entity, the second entity determines whether the redirection of the location management function is successful or not according to the location management capability and configuration of the second entity, and decides to regenerate positioning measurement configuration for the user if it is successful. Therefore, the contents of the handover request acknowledgement message are divided into the following two cases:

In one case, if the second entity does not support the location management capability, the second entity refuses the redirection of the location management function and notifies the UE. The handover request acknowledgement message will include the content and reason of rejection.

In another case, if the second entity supports the location management capability and can reconfigure the location measurement configuration, the second entity accepts the redirection of the location management function and feeds back the new location measurement configuration information. As a non-limiting example, the new configuration information may include the following information:

a new UE measurement ID, used to indicate the new positioning measurement configuration of the UE.

a new UE measurement configuration

uplink measurement configuration information, such as uplink positioning reference signal configuration and other information

downlink measurement configuration information, such as an ID of the downlink reference point to be measured and the corresponding reference signal configuration,

new positioning assistance information, the details of which are as described in the operation 702,

location information of the UE, contents of which are as described in the operation 708.

If the new measurement configuration involves the first entity, and if the first entity is needed to measure the new uplink positioning reference signal of the UE or stop measuring the uplink positioning reference signal of the UE, the first entity accepts and applies the new configuration.

At operation 1103, sending a RRC reconfiguration message by the first entity to the UE, wherein the message may include a new positioning measurement configuration that needs to be notified to the UE, the contents of which are as detailed in the operation 1102.

At operation 1104, the UE receives the RRC reconfiguration information, and resends the uplink positioning reference signal and/or receives the downlink positioning reference signal according to the reconfiguration information.

After the UE completes the configuration, a RRC reconfiguration complete message is sent to the second entity to indicate the new measurement configuration is successfully applied.

In this way, after the handover of the UE is completed, the new service entity can continue to provide positioning services for the UE, and complete positioning measurement results and assistance information can also be obtained, and the UE location can be calculated and sent to the entity or node as needed.

According to the positioning and configuration method of the embodiment of the disclosure, the location management function can be realized on an entity closer to the UE, thus reducing the signaling exchange with the core network and the positioning delay in the positioning procedures. Meanwhile, the method can also ensure the integrity and continuity of the location management function service in the access network in the case of the handover of the UE, particularly in the case of more frequent handover in the non-terrestrial radio access network, and can enable the entity serving the UE to obtain as much reference information and measurement information as possible in time for more accurate positioning.

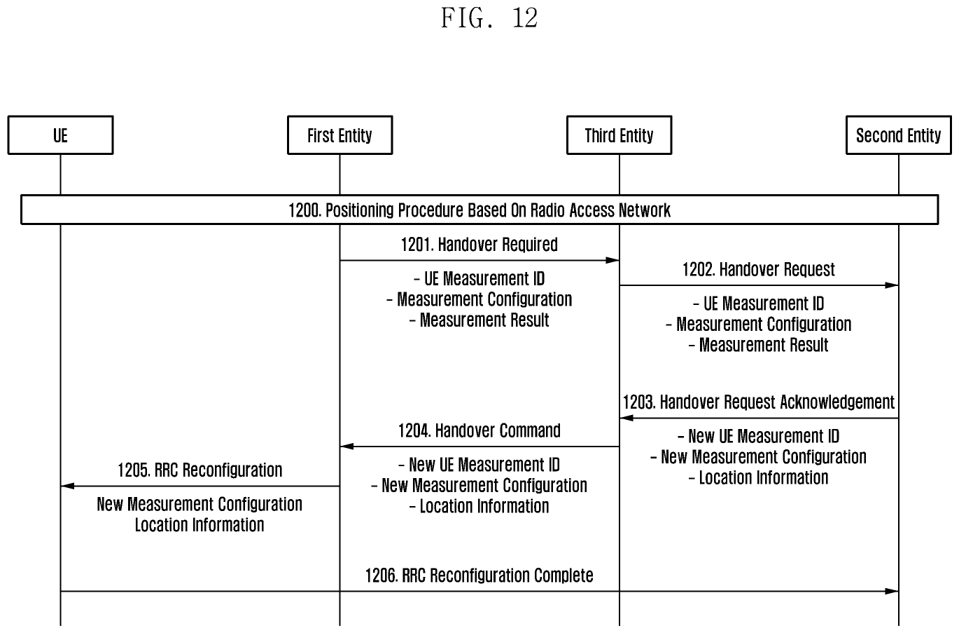

FIG. 12 shows a schematic diagram of a positioning and configuration method according to an embodiment of the disclosure. A description of operations irrelevant to the key points of the disclosure is omitted here.

Referring to FIG. 12, the method includes the following operations:

At operation 1200, initiating a radio access network-based positioning procedure by the first entity to the UE and/or other entities. For example, the first entity and other entities may be base stations, and the other entities may include a second entity. The first entity may have positioning measurement results for the UE, which may be measurement results from the first entity or other entities.

At operation 1201, if the first entity decides to handover UE from the first entity to the second entity, and the first entity cannot communicate directly with the second entity, a third entity is required to transmit messages. The third entity may be a core network node, and the core network node may be an AMF. The first entity sends a handover required message to the third entity, wherein the message includes all positioning information related to the UE, so as to redirect the Location Management Function of the UE. As a non-limiting example, the positioning information may specifically include the following contents:

a UE measurement ID, used to indicate a specific positioning measurement configuration of the UE,

UE measurement configuration, which may include the following:

uplink measurement configuration information, such as uplink positioning reference signal configuration and other information

downlink measurement configuration information, such as an ID of the downlink reference point to be measured and the corresponding reference signal configuration,

positioning assistance information, the details of which are as described in the operation 702,

UE location measurement results, the details of which are as described in the operation 708a/708b.

At operation 1202, sending a handover request message by the third entity to the second entity, and the contents carried in the message are as described in the operation 1101.

At operation 1203, sending a handover request acknowledgement message by the second entity to the third entity. After receiving the positioning information sent by the first entity, the second entity determines whether the redirection of the location management function is successful or not according to the location management capability and configuration of the second entity, and if it is successful, decides to regenerate the positioning measurement configuration for the user. Therefore, the contents of the handover request acknowledgement message are divided into the following two cases:

In one case, if the second entity does not support the location management capability, the second entity refuses the redirection of the location management function and notifies the UE. The handover request acknowledgement message will include the content and reason of rejection.

In another case, if the second entity supports the location management capability and can reconfigure the positioning measurement configuration, the second entity accepts the redirection of the location management function and feeds back new positioning measurement configuration information, which may include the following information:

a new UE measurement ID, used to indicate the new positioning measurement configuration of the UE.

new UE measurement configuration

uplink measurement configuration information, such as uplink positioning reference signal configuration and other information

downlink measurement configuration information, such as an ID of a downlink reference point to be measured and corresponding reference signal configuration

new positioning assistance information, the contents of which are as described in the operation 702.

location information of the UE, the contents of which are as described in the operation 708.

At operation 1204, sending a handover command message by the third entity to the first entity, and the content carried in the message is as described in the operation 1202.

If the new measurement configuration involves the first entity, for example, the first entity is needed to measure the new uplink positioning reference signal of the UE or stop measuring the uplink positioning reference signal of the UE, then the first entity accepts and applies the new configuration.

At operation 1205, sending a RRC reconfiguration message by the first entity to the UE, wherein the message may include new positioning measurement configuration that needs to be notified to the UE, the contents of which are as detailed in the operation 1103.

At operation 1206, the UE receives the RRC reconfiguration information, and resends the uplink positioning reference signal and/or receives the downlink positioning reference signal according to the reconfiguration information.

After the UE completes the configuration, it sends a RRC reconfiguration complete message to the second entity to indicate the new measurement configuration is successfully applied.

In this way, after the handover of the UE based on the core network is completed, the new service entity can continue to provide positioning services for the UE, and can also obtain complete positioning measurement results and assistance information, and calculate the location of the UE and send it to the entity or node as needed.

According to the positioning and configuration method of the embodiment of the disclosure, the Location Management Function can be realized on an entity closer to the UE, thus reducing the signaling exchange with the core network and therefore reducing the positioning delay in the positioning procedures. Meanwhile, the method can also ensure the integrity and continuity of the location management function service in the access network in the case of the handover of the UE based on the core network, and particularly in the case of more frequent handover in the non-terrestrial radio access network, and can enable the entity serving the UE to obtain as much reference information and measurement information as possible in time for more accurate positioning.

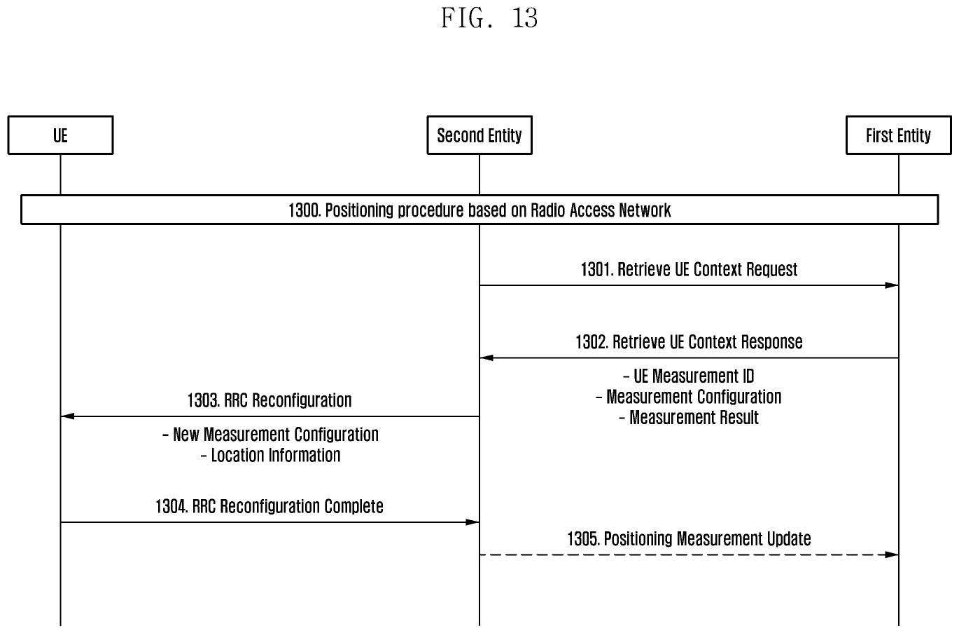

FIG. 13 shows a schematic diagram of a positioning and configuration method according to an embodiment of the disclosure. A detailed description of operations unrelated to the disclosure is omitted here.

Referring to FIG. 13, the method includes the following operations:

At operation 1300, initiating a positioning procedure based on the radio access network by a first entity to UE and/or other entities. For example, the first entity and other entities may be base stations, and the other entities may include a second entity. The first entity may have positioning measurement results for the UE, and the measurement results may be from the first entity or other entities.

At operation 1301, sending a retrieve UE context request message by the second entity to the first entity, wherein the message carries an ID identifying the UE in the first entity and a UE context request.

At operation 1302, sending a retrieve UE context response message by the first entity to the second entity, wherein the message includes all positioning information related to the UE, so as to redirect the location management function for the UE. As a non-limiting example, the positioning information may specifically include the following contents:

a UE measurement ID, used to indicate a specific positioning measurement configuration of the UE,

UE measurement configuration, which may include the following:

uplink measurement configuration information, such as uplink positioning reference signal configuration and other information,

downlink measurement configuration information, such as an ID of the downlink reference point to be measured and the corresponding reference signal configuration,

positioning assistance information, the details of which are as described in the operation 702,

UE location measurement results, the details of which are as described in the operation 708a/708b.

At operation 1302, after receiving the positioning information sent by the first entity, the second entity determines whether the redirection location management function is successful according to the location management capability and configuration of the second entity, and if it is successful, the second entity decides to regenerate positioning measurement configuration for the user. It is divided into the following two cases:

In one case, if the second entity does not support the location management capability, the second entity refuses the redirection of the location management function and notifies the UE.

In another case, if the second entity supports the location management capability and can reconfigure the positioning measurement configuration, the second entity accepts the redirection of the location management function, decides new positioning measurement configuration information, and performs the operation 1303. As a non-limiting example, the new configuration information may include the following information:

a new UE measurement ID, used to indicate the new positioning measurement configuration of the UE.

new UE measurement configuration,

uplink measurement configuration information, such as uplink positioning reference signal configuration and other information,

downlink measurement configuration information, such as an ID of the downlink reference point to be measured and the corresponding reference signal configuration,

new positioning assistance information, the details of which are as detailed in the operation 702,

location information of the UE, the details of which are as detailed in the operation 708a/708b.

At operation 1303, sending a RRC reconfiguration message by the second entity to the UE, wherein the message may include new positioning measurement configuration that needs to be notified to the UE, the details of which are as detailed in the operation 1202.

At operation 1304, the UE receives the RRC reconfiguration information, and resends the uplink positioning reference signal and/or receives the downlink positioning reference signal according to the reconfiguration information.

After the UE completes the configuration, it sends a RRC reconfiguration complete message to the second entity to indicate the new measurement configuration is successfully applied.

At operation 1305, if the new measurement configuration involves the first entity, and if the first entity is needed to measure the new uplink positioning reference signal of the UE, sending a positioning measurement update message by the second entity to the first entity, and the message includes the contents as described in the operation 1302, and the first entity accepts and applies the new configuration. In addition, although not shown in FIG. 13, in one implementation, the new measurement configuration may also instruct the first entity to stop measuring the uplink positioning reference signal of the UE. At this time, the first entity will also accept and apply this configuration.

According to the positioning and configuration method of the embodiment of the disclosure, after the service entity changes after the UE radio link reconstruction or state transition, the new service entity can continue to provide positioning services for the UE, and can also obtain complete positioning measurement results and assistance information, and calculate the location of the UE, and then further send it to the entity or node as needed, so as to apply the location information of the UE to location-related network functions and applications.

According to the positioning and configuration method of the embodiment of the disclosure, the location management function can be realized on an entity closer to the UE, thus reducing the signaling exchange with the core network in the positioning procedures and therefore reducing the positioning delay. Meanwhile, the method can also ensure the integrity and continuity of the Location Management Function service in the access network when the service entity changes after the radio link reconstruction or state transition of the UE, so that the entity serving the UE can obtain as much reference information and measurement information as possible in time, thereby positioning the UE more accurately.

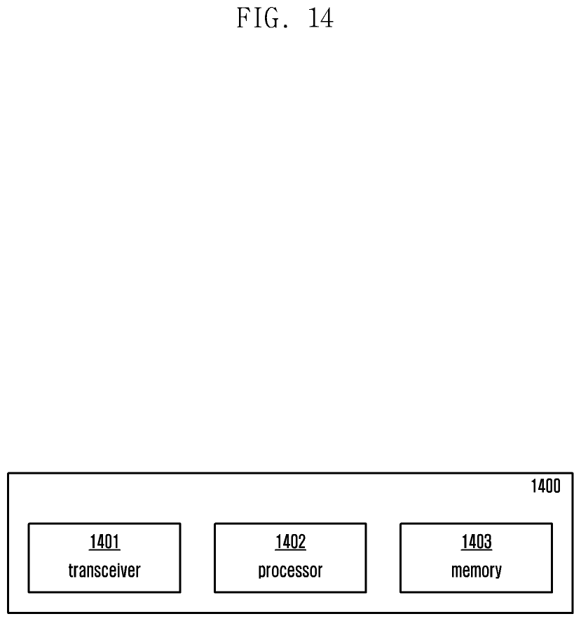

FIG. 14 shows a simplified block diagram of a configuration of hardware components of a device 1400 for positioning and configuration according to an embodiment of the disclosure. The device can implement the method for supporting positioning and configuration according to various embodiments of the disclosure.

The device 1400 can be implemented in any device that can perform relevant operations in the method for positioning and configuration according to the disclosure. As a non-limiting example, the device 1400 can be implemented in network nodes, such as the user equipment, the base station and the core network, or be implemented in components, such as the CU, the DU, the CU-UP and the CU-CP, or be implemented in any similar devices.

Referring to FIG. 14, the device 1400 includes a transceiver unit 1401, a processor 1402 and a memory 1403.

The transceiver unit 1401 is configured to receive and/or transmit signals.

The processor 1402 is operably connected to the transceiver unit 1401 and the memory 1403. The processor 1402 may be implemented as one or more processors and be used to operate according to one or more aspects of the methods for positioning and configuration described in various embodiments of the disclosure.

The memory 1403 is configured to store data. The memory 1403 may include a non-transitory memory for storing operations and/or code instructions that can be executed by the processor 1402. The memory 1403 may include a non-transitory instruction that can be read by the processor, and the instruction, when executed, cause the processor 1402 to implement the operations of the method for positioning and configuration according to various embodiments of the disclosure. The memory 1403 may also include a random access memory or buffer (s) to store intermediate processing data from various functions performed by the processor 1402.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for positioning information request, the method comprising:
transmitting a request for positioning information by a first entity to one or more second entities; and
receiving a response for positioning information by the first entity.

2. The method of claim 1,
wherein the request is one of the following:
a request for positioning assistance information, a request for positioning measurement, or a request for user equipment (UE) geographic location information, and
wherein the response is one of the following:
response of positioning assistance information, response of positioning measurement information, or response of UE geographic location information.

3. The method of claim 2, wherein the positioning assistance information includes at least one of information about a change in a positioning reference point or information about a gateway related to the positioning reference point.

4. The method of claim 3, wherein the information about the change in the positioning reference point includes information indicating a movement trajectory and a corresponding time of the positioning reference point.

5. The method of claim 3, wherein the information about the change of the positioning reference point includes at least one of the following:
non-terrestrial networks ID (NTN ID), NTN beam ID, or NTN gateway ID.

6. The method of claim 5,
wherein the NTN ID comprises a satellite ID, the NTN beam ID comprises a satellite beam ID, and
wherein the NTN gateway ID comprises an ID of a terrestrial gateway connected to a satellite.

7. The method of claim 2,
wherein the request for positioning measurement includes a request for at least one of Doppler measurement, carrier phase measurement, or code phase measurement, and
wherein the positioning measurement information includes at least one of the following:
a doppler shift measurement value, a carrier phase measurement value, a code phase measurement value, a channel model, a channel offset, or a receiving satellite beam number, a satellite ID, an ID of a terrestrial gateway connected to a satellite.

8. The method of claim 2, wherein in a case that the second entity is a UE, the request for positioning measurement and the response of positioning measurement information are transmitted in a radio resource control (RRC) message.

9. The method of claim 8, wherein the message is one of the following:
a RRC reconfiguration message, a positioning measurement request message, or a positioning information request message.

10. The method of claim 1, wherein the request for positioning information and the response of positioning information are transferred using messages of Xn protocol or NRPPa protocol encapsulated in Xn protocol.

11. The method of claim 4, further comprising:
if a trigger event occurs or reaching the time corresponding to an updating period, receiving a positioning information update by the first entity.

12. The method of claim 1, further comprising:
sending positioning measurement configuration by a first entity to a second entity; and
if the positioning measurement configuration changes, sending a message indicating an update of the positioning measurement to the one or more second entities, or
if a positioning procedure ends, sending a message indicating a stop of the positioning measurement to the one or more second entities.

13. The method of claim 12, wherein the first entity and the second entity are one of the following:
the first entity is a base station, and the second entity is one of a base station, a user equipment (UE), a location management function (LMF), a distribute unit (DU) or a central unit (CU);
the first entity is a LMF and the second entity is a base station;
the first entity is a CU, the second entity is one of a DU, a base station, or a CU;
the first entity is a UE and the second entity is a base station;
the first entity is a DU and the second entity is a CU;
the first entity is a CU user plane (CU-UP), and the second entity is one of a CU-CP, a base station, a DU, or a CU;
the first entity is a CU control plane (CU-CP), and the second entity is a CU-UP;
the first entity is a core network and the second entity is a base station; or
the first entity is an entity with a LMF in the base station, and the second entity is one of a CU-CP, a CU-UP, or a DU.

14. The method of claim 2,
wherein the request includes positioning information related to the UE, and
wherein the response includes one of the following:
a content of and a reason for rejection, or new positioning measurement configuration, and
if the response includes new positioning measurement configuration, sending an RRC reconfiguration message including the new positioning measurement configuration by the first entity to the UE.

15. The method of claim 14,
wherein the response includes positioning information related to the UE, and
wherein the method further comprises if the first entity has a location management capability, sending an RRC reconfiguration message including new positioning measurement configuration by the first entity to the UE.

16. The method of claim 15,
wherein the positioning information related to the UE includes one or more of a UE measurement ID, measurement configuration, a measurement result, or positioning assistance information related to the positioning of the UE, and
wherein the new positioning measurement configuration includes one or more of a new UE measurement ID, new measurement configuration, new positioning assistance information, and calculated location information of the UE.

17. The method of claim 1,
wherein the request is a handover request, and the response is a handover request acknowledgement; or
wherein the request is a handover required, and the response is a handover command; or
wherein the request is a retrieve UE context request, and the response is a retrieve UE context response.

18. A method for positioning information request, the method comprising:
receiving a request for positioning information from a first entity by a second entity;
sending response for positioning information by the second entity.

19. The method of claim 18, wherein the request for positioning information and the response for positioning information are transmitted using messages of Xn protocol or NRPPa protocol encapsulated in Xn protocol.

20. A device for positioning information request, the device comprising:
a transceiver, configured to transmit and/or receive signals;
a memory, configured to store data; and
a processor, configured to execute the method of claim 18.
